(19) United States
(12) Patent Application Publication
(10) Pub. No.: US 2014/0013321 A1
(43) Pub. Date: Jan. 9, 2014

(54) METHOD FOR PROVIDING CLOUD COMPUTING RESOURCES

(71) Applicants: Nikolaos LAOUTARIS, Madrid (ES); Rade STANOJEVIC, Madrid (ES); John S. OTTO, Madrid (ES)

(72) Inventors: Nikolaos LAOUTARIS, Madrid (ES); Rade STANOJEVIC, Madrid (ES); John S. OTTO, Madrid (ES)

(73) Assignee: TELEFONICA, S.A., Madrid (ES)

(21) Appl. No.: 13/541,888

(22) Filed: Jul. 5, 2012

(51) Int. Cl. G06F 9/455

(52) U.S. Cl. 718/1

(57) ABSTRACT

A method is described for providing cloud computing resources. The cloud computing resources having a plurality of virtual machine hours and/or bandwidth storage to be provided by a user and intended to attend a number of requests from the user, the requests including a plurality of tasks per second, the method portioning the virtual machine hours uniformly divided in units among several periods of time and providing access to the units virtual machine hours in response to said user's requests and dynamically allocating the cloud computing resources provided, by means of a temporal load awareness scheme.

### FIELD OF THE ART

The present invention refers to computer networking, and more particularly, to a method and a computer program for providing Cloud computing resources.

### PRIOR STATE OF THE ART

Elasticity of resources is one of the main properties of existing Cloud computing platforms that make them an attractive choice for a number of applications. Namely, whenever an application experiences a variable demand for computing resources elastic buying of these resources that depend on demand may reduce the expenditures that come from over-dimensioning. In this context, the main problem faced by an application has to do with over-dimensioning and poor utilization of expensive resources resulting from the fact that owned infrastructure has to be dimensioned according to the peak of a typically highly variable demand. Cloud computing platforms like those offered by Amazon EC2, GoGrid or Rackspace have allowed applications to avoid over dimensioning by applying elastic temporal load aware purchase policies driven by time-varying demand for resources like CPU, I/O, WAN bandwidth, storage, etc.

The existing approach for utilizing the elasticity falls under a general technique of auto-scaling. This approach can be referred, for example, to the situation when a customer purchases dynamically from the platform enough resources at each point of time (e.g., hourly) to ensure a prescribed Quality of Service (QoS) level for its clients (e.g., delay in completing a purchase, or bandwidth for a video stream). Since the cloud permits fast capturing and releasing of resources at a fine granularity, this simple policy can adapt to daily and weekly demand variability and guarantee strict QoS at a minimum charge. A direct consequence of the operation of auto-scaling is that the resulting charge paid to the cloud operator is generally variable and hard to predict.

Elasticity is offered at a flat fee. If for example, a customer wants to take advantage of the elasticity offered by the cloud but would rather pay a flat predefined fee over a certain period of time (day, week, or month) instead of a variable one. Different reasons can give rise to such requirement. Cost predictability is of paramount importance for several companies, especially during their early life when the budget for providing hosting resources is tight. On the other extreme, big customers are not driven by the requirement to guarantee a minimum QoS but would rather like to maximize user satisfaction granted a fixed budget that they can spend over a certain period of time. It can be noticed that the latter objective is not equivalent to maintenance of QoS objective (a la auto-scaling), especially if one considers non-linearity in the satisfaction (user QoS) function and demand unpredictability. Last but not least, the cloud providers themselves can benefit by a scheme in which customers pay flat fees, by committing in advance for longer periods of time. The reason is that in auto-scaling there is no financial long-term commitment on the part of customers and thus the cloud has to perform statistical multiplexing over short periods of time. In flat-fee, the commitment horizon is longer and thus the operator can improve the efficiency of statistical multiplexing and consequently the amortization of the platform. Overall, there exist several historic examples in which success and increasing adoption of a service is pushing for simpler flat pricing schemes.

Many processes that are driven by human activity exhibit variable intensity throughout the day, due to the demographic structure of the user base. In the context of an online service, the generated demand is determined by the demographic structure of its users/clients.

The naive solution to getting a flat charge under the current pricing scheme is to partition an available budget of, C virtual machine instance-hours per day uniformly by providing C/24 machines continuously throughout the day. However, the demand of many services is known to be exhibiting strong variations across time, including daily diurnal patterns as well as day-of-week phenomena. Temporal load awareness calls for a non-uniform split of the C instance-hours across time, such that the number of available instances increases during peak hours, thus benefiting end-user QoS while shrinking during off-peak hours to avoid resource under-utilization.

Some patent applications are providing processes for controlling resources in cloud computing. For example, the solution in US 2008/0008094 which proposes a method for hierarchically distributing rate limits across members of a cluster and for tracking the rate consumption. Another distribution solution proposes for example, a distributed rate limiter which work together to enforce a global rate limit across traffic aggregates at multiple sites, enabling the coordinated policing of a cloud-based service's network traffic. Finally, another solution proposes a predictive elastic resource Scaling (PRESS) scheme for cloud systems which unobtrusively extracts fine-grained dynamic patterns in application resource demands and adjusts their resource allocations.

### SUMMARY OF THE INVENTION

The following description of various embodiments of a method and a computer program providing cloud computing resources is not to be construed in any way as limiting the subject matter of the appended claims.

The object of the present invention is to provide a method to allocate a given amount of Cloud computing resources throughout a period of time in order to maximize the expected performance of an application utilizing the cloud.

To that end, according to an embodiment, the present invention provides a method for providing cloud computing resources, said cloud computing resources comprising a plurality of virtual machine hours and/or bandwidth storage to be provided by a user and intended to attend a number of requests from said user, said requests including a plurality of tasks per second. The method comprises:
a) portioning said virtual machine hours, uniformly and/or non-uniformly, divided in units among several periods of time; and
b) providing access to said units virtual machine hours in response to said user's requests connected through a computing device and dynamically allocating said cloud computing resources provided, by means of a temporal load awareness scheme.

In addition, the temporal load awareness scheme also divides the virtual machine hours into units per day, each day being further split in time slots so that the virtual machine hours are portioned into the time slots.

In general, the cost of the virtual machine hours units portioned are made dependent on a received demand from said user, a daily budget of said virtual machine hours or a combination thereof.

In another embodiment, the access to the units virtual machine hours are provided by:
performing a demand forecasting of said cloud computing resources;
mapping demand and capacity performance by having an accurate identification of the relationship between said plurality of user's tasks per second and said virtual machine hours; and
implementing said temporal load awareness scheme depending on the periodicity of said received demand of said user.

The demand forecasting is performed by using a Sparse Periodic Auto-Regression.

In another embodiment, said temporal load awareness scheme can be performed as an offline solution or as an online solution. In case the received demand from the user follows a periodic demand pattern, the offline solution is performed. In the other hand, if the received demand from the user follows an aperiodic demand pattern, the online solution is performed.

Finally, the received demand can be measured depending on application-specific units of the cloud computing resources such as the number of viewers in a VoD system, the number of objects that needs to be rendering in a photo sharing service, among others.

A second aspect of the invention refers to a computer program comprising software code adapted to perform step b) of claim 1.

### BRIEF DESCRIPTION OF THE DRAWINGS

The previous and other advantages and features will be more fully understood from the following detailed description of embodiments, with reference to the attached, which must be considered in an illustrative and non-limiting manner, in which:

FIG. 1 is a representation of the distribution of the processing time for tweets with and without web page links, according to an embodiment of the invention.

FIG. 2 is a representation of the demand trends rates (tweets per sec) for a 48 hour segment of the twitter trace, according to an embodiment of the invention.

FIG. 3 is a representation of the mean, median and 95th percentile daily response times for TRL and uniform allocation policies, for various budgets, according to an embodiment of the invention.

### DETAILED DESCRIPTION OF SEVERAL EMBODIMENTS

The present invention introduces and analyzes Temporal Rate Limiting (TRL), a purchase policy for cloud resources that enables a customer (e.g., a startup company) to allocate dynamically a predefined purchase budget over a certain period of time so as to optimize the QoS offered to its own clients. TRL is defined as a scheme for introducing temporal load awareness in the control of elastic resources provided from a cloud infrastructure.

The invention provides a method to allocate a given amount of the Cloud computing resources (for example C virtual machine (VM)-hours) throughout a period of time to maximize the expected performance of the application utilizing the cloud.

For applications that exhibit large temporal variations in the demand, allocating more Cloud computing resource in the hours of high-demand and releasing the corresponding resource during off-peak hours can result in significant performance improvements due to non-linear dependence between the provided (instantaneous) capacity and the (instantaneous) performance.

In an example embodiment and considering a customer that has a budget of C units (VM-hours) per day for running elastic services in the cloud. The day is split in T time slots (T=24 hours) and the budget is split between these T slots in an arbitrary manner by buying Cₜ resource-units at time t. It is also assumed that the cost of resource-unit can change in time and is given by rt at time slot t. The demand is also measured in application-specific units (number of viewers in a VoD system, number of objects that need rendering in a photo sharing service, etc.) and is represented by the time series: D₁, . . . , T_{T}. Then the performance at time slot t is measured through a metric q that is a (monotone) function of the demand intensity Dₜ and the capacity Cₜ:

qₜ=f(Cₜ;Dₜ)=fₜ(Cₜ):

The goal of TRL is finding the allocation C=(C₁ . . . C_{T}) of budget C that optimizes the expected daily performance:

Q(C)=q₁+q₂+ . . . +qr (1)

such that:

r₁C₁+r₂C₂+ . . . +r_{T}Cₜ=C (2)

Off-line solution to TRL:

In an embodiment example for the off-line solution, all the parameters are assumed to be known in advance, and the solution to the problem (1)-(2) is relatively straightforward and discussed in following paragraphs. It is also possible to derive closed-form solutions for several specific scenarios as it is showed later. One can easily notice that the problem (1)-(2) is a standard non-linear convex optimization problem with a linear constraint. One way to solve that problem is to employ the gradient ascent method. However, alternatively one can derive more intuition on the nature of the optimal point by taking advantage of the structure of the optimization problem. Namely, let λ be the Lagrange multiplier of the optimization problem, then it is straightforward to see that the vector C that minimizes Q(C) must satisfy:

fₜ(Cₜ)=λrₜ (3)

Implementing TRL online:

In another embodiment, for implementing the online TRL solution, several practical problems from the off-line solution embodiment have to be solved. For example, in order to decide on how many resources (virtual machines) are needed to buy at time slot t under a budgeting constraint to optimize the performance over a time horizon. In particular, the main concerns in the design of online TRL are: (1) demand forecasting; (2) accurate identification of the relationship f(C; D) between offered demand D (jobs per second), capacity C (number of VMs); and (3) actual control system for determining the number of VMs to buy, subject to the budget and optimization criteria.

Demand forecasting: For demand forecasting the Sparse Periodic Auto-Regression (SPAR) estimator developed is used. The demand Dₜ at time t is forecasted as:

$${D}_{t} = {\sum }_{i = 1}^{{n}_{0}} {α}_{i} {D}_{t - i \cdot T} + {\sum }_{j = 1}^{{n}_{1}} {β}_{j} Δ {D}_{t - j} , \\ Δ {D}_{t - j} = {D}_{t - j} - \frac{1}{{n}_{0 }} {\sum }_{i = 1}^{{n}_{0}} {D}_{t - j - i \cdot T} .$$

where α's and β's are obtained through the least squares method. The first part of the above model does the periodic prediction over a time period T that corresponds to 24 hours here. Interestingly, higher order models result in minor improvement over the first order model (n₀=n₁=1) and throughout this patent we use n₀=n₁=1.

Mapping demand and capacity to performance: In order to use the insights from the off-line solution embodiment and solve the optimization problem (1)-(2) it is needed to know the functions fₜ(Cₜ)=f(Dₜ;Cₜ)=qᵢ, that relate performance qᵢ with generated demand Dᵢ and the offered capacity Cᵢ. These functions can be modeled for some simple systems with known job size distributions; this is the case for example in the closed form results that could be derived involving for example M/M/1 queue with variable capacity. However, in general, accurate identification of function f(.,.) requires fine-grained benchmarks for a range of values of demand and capacity that we perform in an off-line manner.

Online TRL: For those services that have purely periodic demand pattern, accurate enough long-term demand prediction can be hat and can be applied the framework from the off-line solution to directly solve the problem in an off-line manner. However, many services have a demand pattern that is more volatile and harder to predict at a time scales greater than one hour. For that reason, it is choose to solve the optimization problem with ‘soft’ budget constraint as follows. The key observation is that the point C=(C₁ . . . C_{T}) that maximizes the expected utility satisfies (3). Instead of picking one λ to solve the system exactly, the invention continually searches for it, using a feedback control loop. Namely, the internal variable λ(t) is kept, and Cₜ determined as:

Cₜ=(fₜ′(rₜλ(t))

where fₜ(x)=f(Dₜ; x) is the function for the forecasted value of demand Dₜ at time t. Then λ is updated to account for the difference between used resource during the preceding T time slots and the cost constraint C:

$$λ ( t + 1 ) = λ ( t ) ( 1 + η ( C - {\sum }_{i = 0}^{T - 1} {r}_{t - i} {C}_{t - i} ) ) ,$$

where η>0 is the gain parameter such that in steady state λ(t) is stabilized around the optimal value. For the experimental results presented later the gain parameter η=0.1/C is used. The online TRL does not strictly enforce the cost constraint (2) over the time period of T time slots, but rather strives to keep long-term average cost at the desired level C. The pseudo code of online TRL is given bellow:

$$\begin{matrix}1 & TRL\_online ( ) \\ 2 & At time slot t do \\ 3 & {D}_{t} = forecast ( {D}_{0} , … , {D}_{t - 1} ) \\ 4 & {C}_{t} is such that \frac{d f ( {D}_{t} , {C}_{t} )}{d {C}_{t}} = {r}_{t} λ ( t ) \\ 5 & λ ( t + 1 ) = λ ( t ) ( 1 + η ( {\sum }_{i = 0}^{T - 1} {r}_{t - i} {C}_{t - i} - C ) ) \\ 6 & enddo \end{matrix}$$

Advantages of TRL:

In order to understand the behavior of TRL on a real cloud platform and factor the potential impacts of virtualization TRL on Amazon's EC2 cloud is deployed and used it to control the number of virtual machines that check tweets for evidence of SPAM. In this case TRL provided a significant improvement in mean application response time, which in certain cases was an order of magnitude better than uniform allocation.

Twitter Blacklisting: In an embodiment, a blacklisting application is adopted for a microblogging service (e.g. Twitter) that searches the content and linked web pages of microblog posts (“tweets”) for a set of blacklisted words or patterns. A similar service is offered by filttr[], a startup that processes tweets based on appropriate keyword filters. This application can be used for blocking spam or allow users to build personalized filters. In this embodiment, the invention looks for a subset of the patterns in the regular expression blacklist used by wikimedia.org [] to block spam.

To process a tweet, the invention first identifies URLs and fetches the content of linked documents. For each HTTP URL, the headers are read to determine the MIME type of the document (following any HTTP 30X redirections), and downloaded the entire content if it is a text or HTML file. Then, it iterates over each of the elements in the blacklist, scanning the text of the tweet and that of all its linked web pages. The invention the, returns the tweet with a list of all the blacklist elements that matched, as well as a list of the web pages that were scanned.

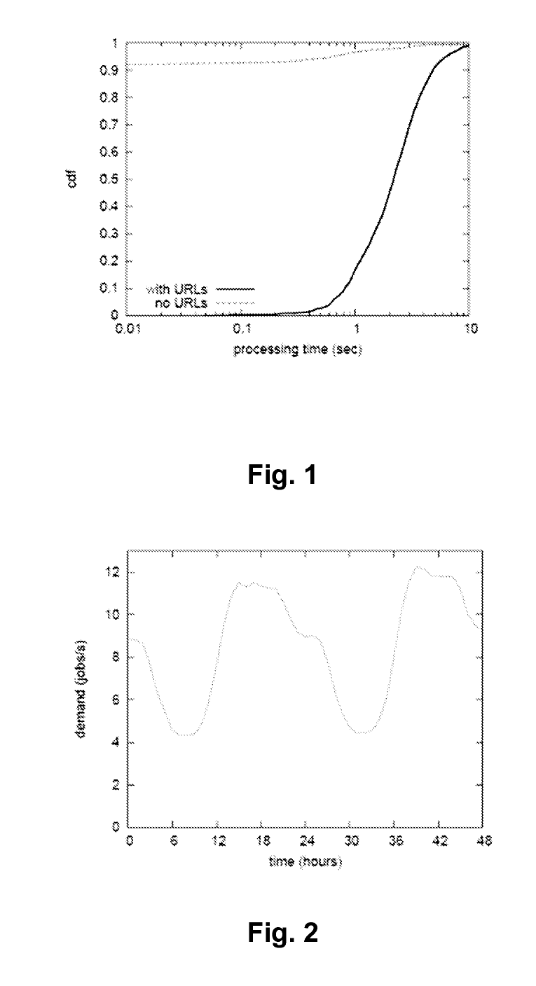

Approximately 36% of the tweets in the dataset that were used contained at least one link to an HTML or text document. FIG. 1 shows the distributions of processing time for tweets with and without URLs. Without URLs, the average processing time is only 173 milliseconds (ms), which are significantly higher than the median of 0.9 ms because about 10% of these tweets have URLs that point to documents that are not HTML or text files. In these cases, it takes time to read the HTTP headers to determine the type of content on the page. For tweets with URLs, the average processing time is about 2.66 seconds.

Performance evaluation: In another embodiment, the performance of the invention running under TRL in comparison to a uniform allocation model (in which at all times application uses C/24 VMs) in terms of several response time metrics is also evaluated. The response time is defined to be the latency from when a job is sent by the client until it is received at the client. For each experiment, either TRL or the uniform allocator as the policy to define how many servers to use is selected, and defined a daily budget to limit the total number of server hours. The smallest budget is defined as that in which would allow the uniform allocation policy to have sufficient server time to run the necessary 10 servers (at full processing capacity) for the whole day—240 server hours. From here, the number of servers that can be run for the whole day to 18 (432 server hours) is increased.

A two-day region of the Twitter trace is used, covering all of a Tuesday and Wednesday, for each experiment. FIG. 2 shows the trends in demand, in tweets per second, for these two days of the trace.

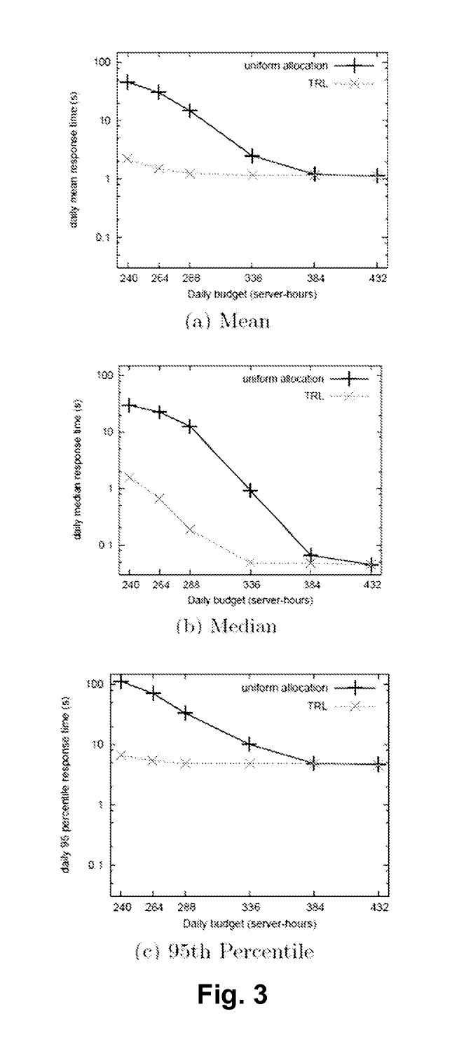

FIG. 3 illustrates mean, median, and 95th percentile response time for all the budgets that were tested. In that case, TRL provides performance at least as good as the uniform allocator across all metrics.

TRL provides the most significant performance improvement (over an order of magnitude reduction in response time) relative to the uniform allocator when the system is given a small budget. For example, when the uniform allocator is given only 240 server hours it is only able to run 10 servers. During the heavily loaded portion of the day (e.g. hours 38-44), the uniform allocator system has significant queuing delays. In contrast, TRL allocates fewer of its server hours during periods of low demand, and is thus able to afford to scale up the number of servers for periods of high demand. As a result, TRL is better able to avoid queuing delays, even when demand is high.

For both systems, increasing the budget improves performance for all three metrics—but only to a point. For example, increasing the budget by 40% from 240 to 336 server hours results in an order-of-magnitude reduction in response time for the uniform allocator system. However, increasing the budget from 384 to 432 server hours yields only a very small increase in performance for both systems.

The reduction in marginal performance gains as the budget occurs is increased because the lower bound of these metrics is reached, given the invention's characteristics. For example, the average per-tweet processing time is about 0.8 sec, and the invention daily mean response time plateaus at just over 1 sec (with a budget of 432 server hours). Likewise, the 95th percentile metric curves also flatten out (at about 10 sec) under large budgets because the 5% of the tweets with the longest processing time take at least 10 sec.

1. A method for providing cloud computing resources, said cloud computing resources comprising a plurality of virtual machine hours and/or bandwidth storage to be provided by a user and intended to attend a number of requests from said user, said requests including a plurality of tasks per second, said method comprising:
a) portioning said virtual machine hours, uniformly and/or non-uniformly, divided in units among several periods of time; and
b) providing access to said units virtual machine hours in response to said user's requests connected through a computing device and dynamically allocating said cloud computing resources provided, by means of a temporal load awareness scheme.

2. A method according to claim 1, wherein said temporal load awareness scheme comprises dividing said virtual machine hours into units per day, each day being further split in time slots so that said virtual machine hours are portioned into said time slots.

3. A method according to claim 2, wherein the cost of said virtual machine hours units portioned are made dependent on a received demand from said user, a daily budget of said virtual machine hours or a combination thereof.

4. A method according to claim 1, wherein providing said access to said units virtual machine hours further comprising:
performing a demand forecasting of said cloud computing resources;
mapping demand and capacity performance by having an accurate identification of the relationship between said plurality of user's tasks per second and said virtual machine hours; and
implementing said temporal load awareness scheme depending on the periodicity of said received demand of said user.

5. A method according to claim 4, wherein said demand forecasting uses a Sparse Periodic Auto-Regression, where the demand Dₜ a time t is given by:
$${D}_{t} = {\sum }_{i = 1}^{{n}_{0}} {α}_{i} {D}_{t - i \cdot T} + {\sum }_{j = 1}^{{n}_{1}} {β}_{j} Δ {D}_{t - j} , \\ Δ {D}_{t - j} = {D}_{t - j} - \frac{1}{{n}_{0}} {\sum }_{i = 1}^{{n}_{0}} {D}_{t - j - i \cdot T} .$$

6. A method according to claim 4, wherein in case said received demand from said user follow a periodic demand pattern, an offline solution of said temporal load awareness scheme is performed.

7. A method according to claim 6, wherein said offline solution of said temporal load awareness scheme is given by:
fₜ(Cₜ)=λrₜ
where, λ is a Lagrange multiplier of the optimization problem and rₜ said virtual machine hours in a time t.

8. A method according to claim 6, wherein said offline solution of said temporal load awareness scheme is given by standard non-linear convex optimization method such as the gradient ascent method.

9. A method according to claim 4, wherein in case said received demand from said user follow an aperiodic demand pattern an online solution of said temporal load awareness scheme is performed.

10. A method according to claim 9, wherein said online solution of said temporal load awareness scheme is given by:
$${C}_{t} = ( {f}_{t}^{′} ( {r}_{t} λ ( t ) ) ; and \\ λ ( t + 1 ) = λ ( t ) ( 1 + η ( C - {\sum }_{i = 0}^{T - 1} {r}_{t - i} {C}_{t - i} ) ) ,$$

11. A method according to claim 3, comprising measuring said received demand from said user depending on application-specific units of said cloud computing resources such as the number of viewers in a VoD system, the number of objects that needs to be rendering in a photo sharing service, among others.

12. A computer program comprising software code adapted to perform step b) of claim 1.

13. A method according to claim 2, wherein providing said access to said units virtual machine hours further comprising:
performing a demand forecasting of said cloud computing resources;
mapping demand and capacity performance by having an accurate identification of the relationship between said plurality of user's tasks per second and said virtual machine hours; and
implementing said temporal load awareness scheme depending on the periodicity of said received demand of said user.

14. A method according to claim 13, wherein said demand forecasting uses a Sparse Periodic Auto-Regression, where the demand Dt a time t is given by:

15. A method according to claim 13, wherein in case said received demand from said user follow a periodic demand pattern, an offline solution of said temporal load awareness scheme is performed.

16. A method according to claim 15, wherein said offline solution of said temporal load awareness scheme is given by:
ft(Ct)=λrt
where, λ is a Lagrange multiplier of the optimization problem and rt said virtual machine hours in a time t.

17. A method according to claim 15, wherein said offline solution of said temporal load awareness scheme is given by standard non-linear convex optimization method such as the gradient ascent method.

18. A method according to claim 13, wherein in case said received demand from said user follow an aperiodic demand pattern an online solution of said temporal load awareness scheme is performed.

19. A method according to claim 18, wherein said online solution of said temporal load awareness scheme is given by:
$${C}_{t} = ( f {t}^{′} ( rt λ ( t ) ) ; and \\ λ ( t + 1 ) = λ ( t ) ( 1 + η ( C - {\sum }_{i = 0}^{T - 1} {r}_{t - i} {C}_{t - i} ) ) ,$$
